(19) United States
(12) Patent Application Publication
(10) Pub. No.: US 2012/0274666 A1
(43) Pub. Date: Nov. 1, 2012

(54) SYSTEM AND METHOD FOR TUNING MULTI-COLOR DISPLAYS

(75) Inventors: Koorosh Aflatooni, Cupertino, CA (US); Tao Yu, Campbell, CA (US); Court A. Arning, San Jose, CA (US); Farnaz Parhami, Fremont, CA (US); Nathaniel R. Bennett, Menlo Park, CA (US)

(73) Assignee: QUALCOMM MEMS Technologies, Inc., San Diego, CA (US)

(21) Appl. No.: 13/279,161

(22) Filed: Oct. 21, 2011

Related U.S. Application Data
(60) Provisional application No. 61/453,087, filed on Mar. 15, 2011.

(51) Int. Cl. G09G 5/10

(52) U.S. Cl. 345/690

(57) ABSTRACT

This disclosure provides systems, methods and apparatuses, including computer programs encoded on computer-readable storage media, for calibrating a display. In one aspect, a method of calibrating a display includes determining one or more array voltages and, based on the determined array voltages, determining one or more drive scheme voltages. The determined drive scheme voltages may include, for example, a single segment voltage applied to all of the display elements of the array, and multiple common voltages applies to multiple subsets of the display elements of the array.

### CROSS-REFERENCE TO RELATED APPLICATIONS

This application claims priority under 35 U.S.C. §119(e) to U.S. Provisional Application No. 61/453,087, filed Mar. 15, 2011, which is hereby incorporated by reference in its entirety.

### TECHNICAL FIELD

This disclosure relates to selecting drive scheme voltages for driving a display.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of calibrating a display. The method can include determining, for each of the first, second, and third pluralities of display elements, a first voltage, the lowest voltage which, when applied to each display element of a respective plurality of the pluralities of display elements, causes at least one display element of the respective plurality of display elements to actuate. The first plurality of display elements can be associated with a first color. The second plurality of display elements can be associated with a second color. The third plurality of display elements can be associated with a third color. The method can further include determining, for each of the first, second, and third pluralities of display elements, a second voltage, the lowest voltage which, when applied to each display element of the respective plurality of display elements, causes substantially all of the display elements within the respective plurality of display elements to actuate. The method can further include determining, for each of the first, second, and third pluralities of display elements, a third voltage, the highest voltage which, when applied to each display element of the respective plurality of display elements, causes at least one of the display elements to release. The method can further include selecting a segment voltage based on the determined first, second, and third voltages. The method can further include selecting first, second, and third hold voltages for the first, second, and third pluralities of display elements, respectively, based at least in part on the segment voltage.

In some implementations, the method further includes selecting one or more drive scheme voltages based at least in part on the selected segment voltage and the first, second, and third hold voltages. In some implementations, the method further includes modifying at least one of the selected segment voltage and the first, second, and third hold voltages for use in a drive scheme. In some implementations, the method further includes applying the selected segment voltage and the first, second, and third hold voltages to the display in accordance with a drive scheme and determining whether the selected segment voltage and the first, second, and third hold voltages are suitable for use in the drive scheme.

In some implementations, the method can further include determining, for each of the first, second, and third pluralities of display elements, a fourth voltage, the highest positive voltage which, when applied to each display element of the respective plurality of the pluralities display elements, causes substantially all of the respective plurality of display elements to release.

In some implementations, selecting a segment voltage includes determining a first, second, and third potential segment voltage based, respectively, on the determined first, second, and third voltages for the first, second, and third plurality of display elements and selecting one of the first, second, and third potential segment voltages as the selected segment voltage. In some implementations, the potential segment voltage with the lowest magnitude is selected. In some other implementations, the potential segment voltage associated with the plurality of display element associated with the solution space having the smallest area is selected.

Another innovative aspect of the subject matter described in this disclosure can be implemented in a system for calibrating a display. The display can include a first plurality of display elements of a first color, a second plurality of display elements of a second color, and a third plurality of display elements of a third color. The system may include an array driver configured to apply a voltage to the first, second, and third pluralities of display elements and a processor. The processor may be configured to (1) control the array driver, (2) determine, for each of the first, second, and third pluralities of display elements, a first voltage, the lowest voltage which, when applied to each display element of a respective plurality of the pluralities of display elements, causes at least one display element of the respective plurality of display elements to actuate, (3) determine, for each of the first, second, and third pluralities of display elements, a second voltage, the lowest voltage which, when applied to each display element of the respective plurality of display elements, causes substantially all of the display elements within the respective plurality of display elements to actuate, (4) determine, for each of the first, second, and third pluralities of display elements, a third voltage, the highest voltage which, when applied to each display element of the respective plurality of display elements, causes at least one display element of the display elements to release, (5) select a segment voltage based on the determined first, second, and third voltages, and (6) select first, second, and third hold voltages for the first, second, and third pluralities of display elements, respectively, based at least in part on the segment voltage.

In some implementations, the processor is configured to select one or more drive scheme voltages based at least in part on the selected segment voltage and the first, second, and third hold voltages. In some implementations, the processor is configured to modify at least one of the selected segment voltage and the first, second, and third hold voltages for use in a drive scheme. In some implementations, the processor is configured to control an array driver to apply the selected segment voltage and the first, second, and third hold voltages to the display in accordance with a drive scheme and to determine whether the selected segment voltage and the first, second, and third hold voltages are suitable for use in the drive scheme.

In some implementations, the processor is configured to determine, for each of the first, second, and third pluralities of display elements, a fourth voltage, the highest positive voltage which, when applied to each display element of the respective plurality of all the pluralities of display elements, causes substantially all of the display elements within the respective plurality of display elements to release.

In some implementations, the processor selects a segment voltage by determining a first, second, and third potential segment voltage based, respectively, on the determined first, second, and third voltages for the first, second, and third plurality of display elements and selecting one of the first, second, and third potential segment voltages as the selected segment voltage. In some implementations, the potential segment voltage with the lowest magnitude is selected. In some implementations, the potential segment voltage associated with the plurality of display element associated with the solution space having the smallest area is selected.

Another innovative aspect of the subject matter described in this disclosure can be implemented in a system for calibrating a display. The display can include a first plurality of display elements of a first color, a second plurality of display elements of a second color, and a third plurality of display elements of a third color.

The system can include means for determining, for each of the first, second, and third pluralities of display elements, a first voltage, the lowest voltage which, when applied to each display element of a respective plurality of the pluralities of display elements, causes at least one display element of the respective plurality of display elements to actuate. The system can further include means for determining, for each of the first, second, and third pluralities of display elements, a second voltage, the lowest voltage which, when applied to each display element of the respective plurality of display elements, causes substantially all of the display elements within the respective plurality of display elements to actuate. The system can further include means for determining, for each of the first, second, and third pluralities of display elements, a third voltage, the highest voltage which, when applied to each display element of the respective plurality of display elements, causes at least one display element of the display elements to release. The system can further include means for selecting a segment voltage based on the determined first, second, and third voltages. The system can further include means for selecting first, second, and third hold voltages for the first, second, and third pluralities of display elements, respectively, based at least in part on the segment voltage.

In some implementations, the system further includes means for selecting one or more drive scheme voltages based at least in part on the selected segment voltage and the first, second, and third hold voltages. In some implementations, the system further includes means for modifying at least one of the selected segment voltage and the first, second, and third hold voltages for use in a drive scheme. In some implementations, the system further includes means for applying the selected segment voltage and the first, second, and third hold voltages to the display in accordance with a drive scheme and means for determining whether the selected segment voltage and the first, second, and third hold voltages are suitable for use in the drive scheme.

In some implementations, the system further includes means for determining, for each of the first, second, and third pluralities of display elements, a fourth voltage, the highest positive voltage which, when applied to each display element of the respective plurality of the pluralities of display elements, causes substantially all of the respective plurality of display elements to release.

In some implementations, the means for selecting a segment voltage includes means for determining a first, second, and third potential segment voltage based, respectively, on the determined first, second, and third voltages for the first, second, and third pluralities of display elements and means for selecting one of the first, second, and third potential segment voltages as the selected segment voltage.

Another innovative aspect of the subject matter described in this disclosure can be implemented in a computer-readable storage medium having computer-executable instructions encoded thereon for performing a method of calibrating a display. The display can include a first plurality of display elements of a first color, a second plurality of display elements of a second color, and a third plurality of display elements of a third color. The encoded method can include determining, for each of the first, second, and third pluralities of display elements, a first voltage, the lowest voltage which, when applied to each display element of a respective plurality of the pluralities of display elements, causes at least one display element of the respective plurality of display elements to actuate. The method can include determining, for each of the first, second, and third pluralities of display elements, a second voltage, the lowest voltage which, when applied to each display element of the respective plurality of display elements, causes substantially all of the display elements within the respective plurality of display elements to actuate. The method can include determining, for each of the first, second, and third pluralities of display elements, a third voltage, the highest voltage which, when applied to each display element of the respective plurality of display elements, causes at least one of the display elements to release. The method can include selecting a segment voltage based on the determined first, second, and third voltages. The method can include selecting first, second, and third hold voltages for the first, second, and third pluralities of display elements, respectively, based at least in part on the segment voltage.

In some implementations, the encoded method include selecting one or more drive scheme voltages based at least in part on the selected segment voltage and the first, second, and third hold voltages. In some implementations, the encoded method further includes modifying at least one of the selected segment voltage and the first, second, and third hold voltages for use in a drive scheme. In some implementations, the encoded method further includes applying the selected segment voltage and the first, second, and third hold voltages to the display in accordance with a drive scheme and determining whether the selected segment voltage and the first, second, and third hold voltages are suitable for use in the drive scheme.

In some implementations, the encoded method further includes determining, for each of the first, second, and third pluralities of display elements, a fourth voltage, the highest positive voltage which, when applied to each display element of the respective plurality of the pluralities of display elements, causes substantially all of the display elements within the respective plurality of display elements to release.

In some implementations, selecting a segment voltage includes determining a first, second, and third potential segment voltage based, respectively, on the determined first, second, and third voltages for the first, second, and third plurality of display elements and selecting one of the first, second, and third potential segment voltages as the selected segment voltage.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent display elements in a series of display elements of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a diagram illustrating movable reflective mirror position versus applied voltage for a number of different interferometric modulators.

FIG. 10 shows an example of a graph illustrating inequalities that can be used in selecting drive scheme voltages.

FIG. 11 shows an example of a graph illustrating inequalities that can be used in selecting drive scheme voltages for multiple colors.

FIG. 12 shows an example of a flow diagram illustrating a method of selecting drive scheme voltages.

FIG. 13 shows an example of a flow diagram illustrating a method of driving an array.

FIG. 14 shows a system block diagram of an example test fixture.

FIGS. 15A and 15B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Devices and methods related to determining drive scheme voltages are described herein. The configurations of the devices and methods are described with respect to optical EMS and MEMS devices, particularly interferometric modulator display devices. However, a person having ordinary skill in the art will recognize that similar devices and methods may be used with other appropriate display technologies.

Generally, display arrays are formed as arrays of physical pixels. For many display arrays, especially gray scale and color display arrays, each physical pixel is made up of a group of display elements, where each display element can be selectively placed into two or more states with different visually perceptible outputs. Pixels of numerical input image data are mapped onto physical pixels of the display array, and the display elements of the group are placed in states that collectively produce a visually perceptible representation of the input image data, either by themselves, or in conjunction with other neighboring pixels of the display array. For some display technologies, a display element can be characterized by voltages at which the element changes state. However, in an array of elements, there may not be perfect uniformity, and different elements may transition to different states at slightly different voltages. This non-uniformity may arise, for example, from slight differences in material thicknesses or other properties in different parts of the array that inevitably occur in the manufacturing process. Thus, drive scheme voltages suitable for certain elements, may be unsuitable for other elements. In some implementations described herein, drive scheme voltages are determined based on voltage levels determined by applying a variable voltage and observing display elements over the entire array. The voltage levels may be observed as those voltage levels where display elements just begin to actuate, and those voltage levels that result in all or substantially all display elements actuating. Using these observed voltage levels, suitable drive scheme voltages for the array that works for all, or substantially all the display elements may be derived.

Particular implementations of the subject matter described in this disclosure can be implemented to realize one or more of the following potential advantages. By determining drive scheme voltages based on observation of the entire array, the drive scheme can operate successfully on all or at least nearly all of the display elements without accidental actuation or accidental release. This improves display performance because if display elements are released when they should be actuated or actuated when they should be released, the visual appearance of the display will deviate from the intended appearance based on the input image data.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

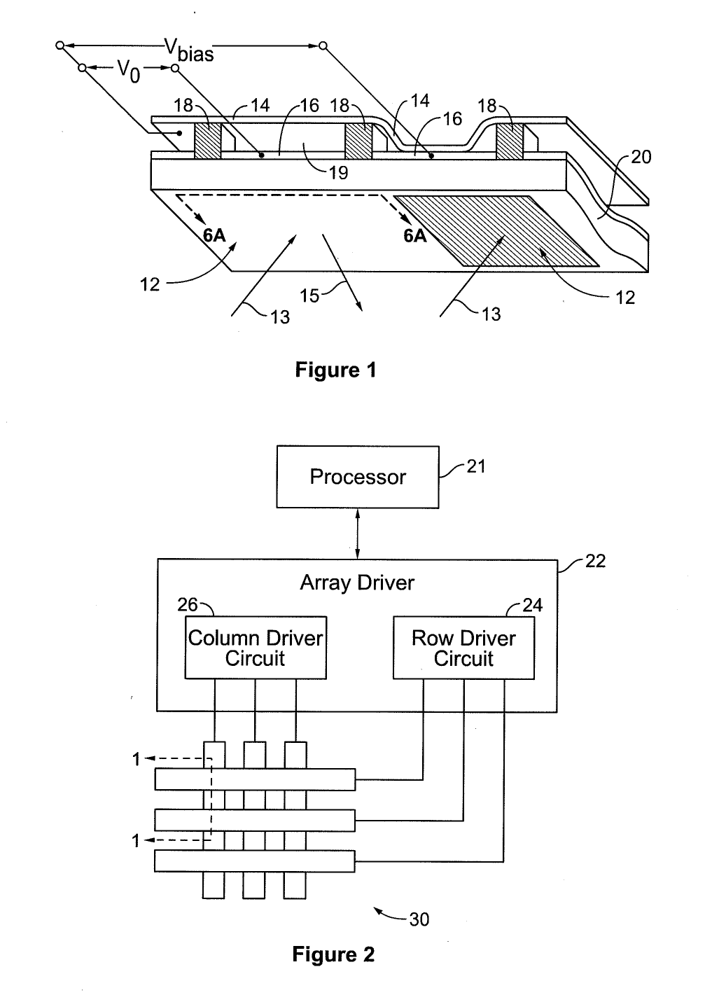

FIG. 1 shows an example of an isometric view depicting two adjacent display elements in a series of display elements of an interferometric modulator (IMOD) display device. The IMOD display device includes one or more interferometric MEMS display elements. In these devices, the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS display elements can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each display element. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the display elements to change states. In some other implementations, an applied charge can drive the display elements to change states.

The depicted portion of the display element array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of display elements 12 are generally illustrated with arrows 13 indicating light incident upon the display elements 12, and light 15 reflecting from the display element 12 on the left. Although not illustrated in detail, it will be understood by a person having ordinary skill in the art that most of the light 13 incident upon the display elements 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the display element 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD display elements. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each display element of the IMOD, whether in the actuated or relaxed state, is essentially a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior is the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

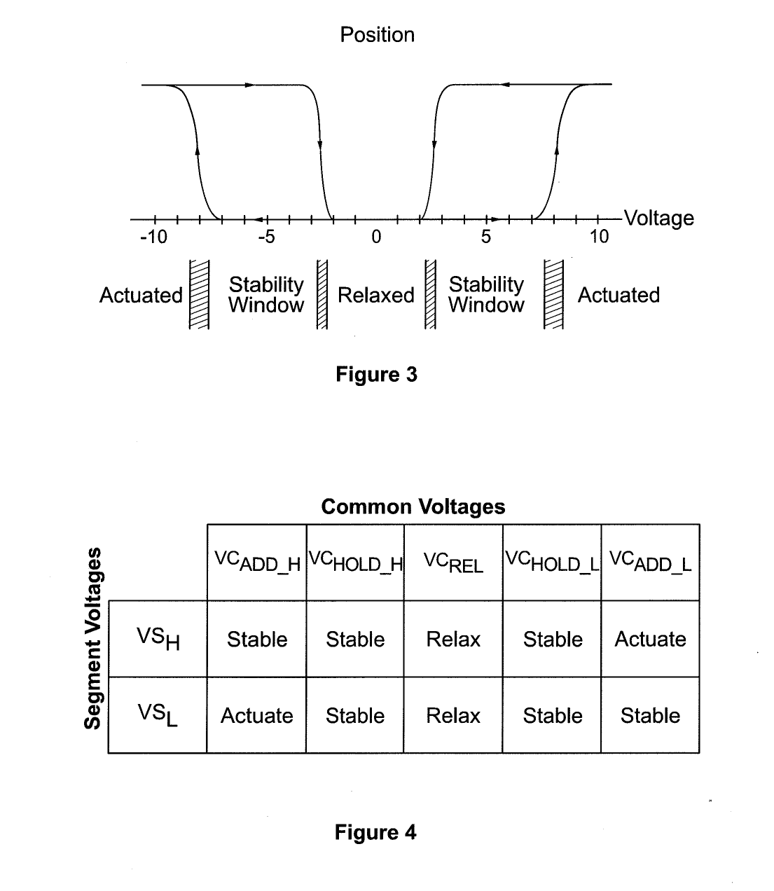

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, display elements in the addressed row that are to be actuated are exposed to a voltage difference of about 10-volts, and display elements that are to be relaxed are exposed to a voltage difference of near zero volts. After addressing, the display elements are exposed to a steady state or bias voltage difference of approximately 5-volts such that they remain in the previous strobing state. In this example, after being addressed, each display element sees a potential difference within the “stability window” of about 3-7-volts. This hysteresis property feature enables the display element design, e.g., illustrated in FIG. 1, to remain stable in either an actuated or relaxed pre-existing state under the same applied voltage conditions. Since each IMOD display element, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each display element (that is, the potential difference across each display element) determines the resulting state of each display element. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

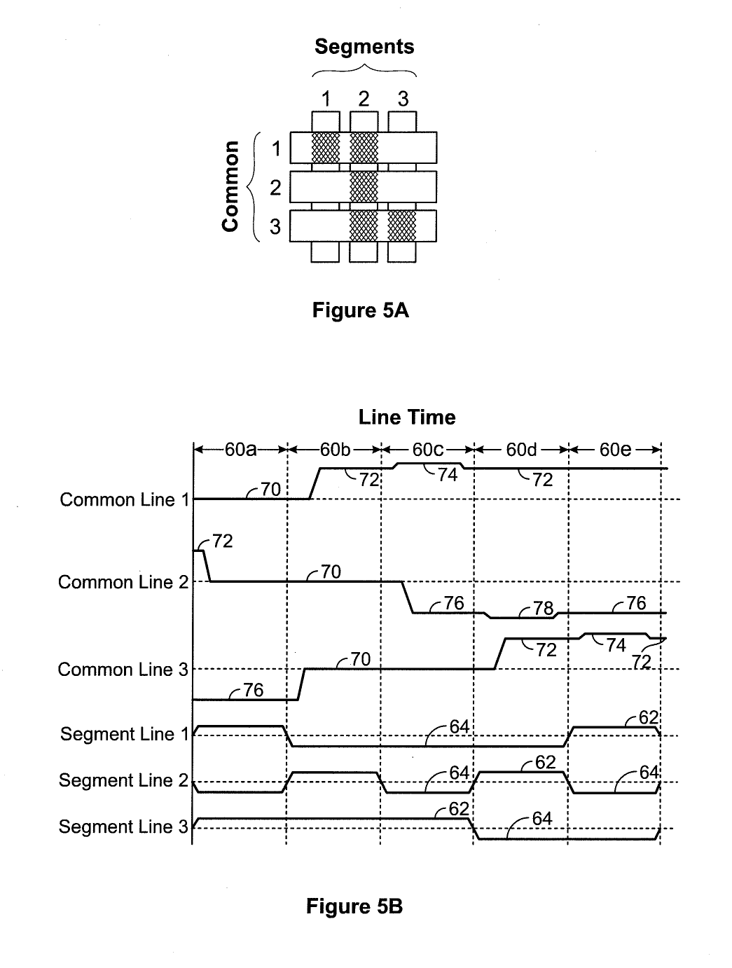

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a display element voltage) is within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then the voltage on common line 2 transitions back to low hold voltage 76.

Finally, during the fifth line time 60e, the voltage on common line 1 remains at high hold voltage 72, and the voltage on common line 2 remains at low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

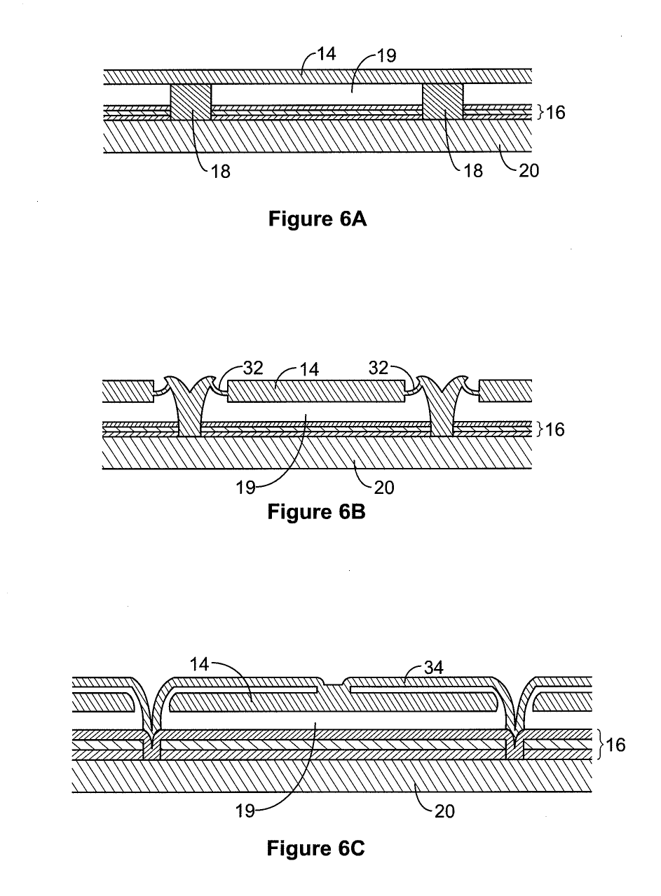

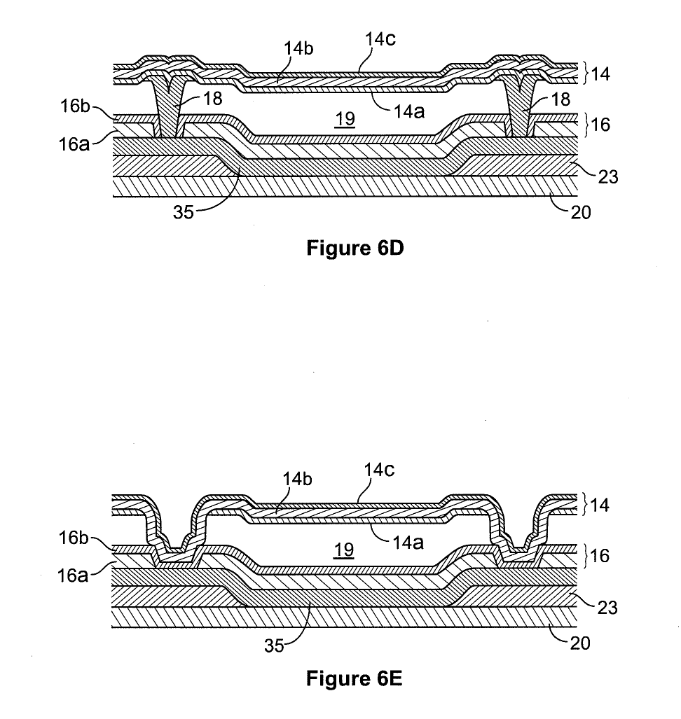

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between display elements or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

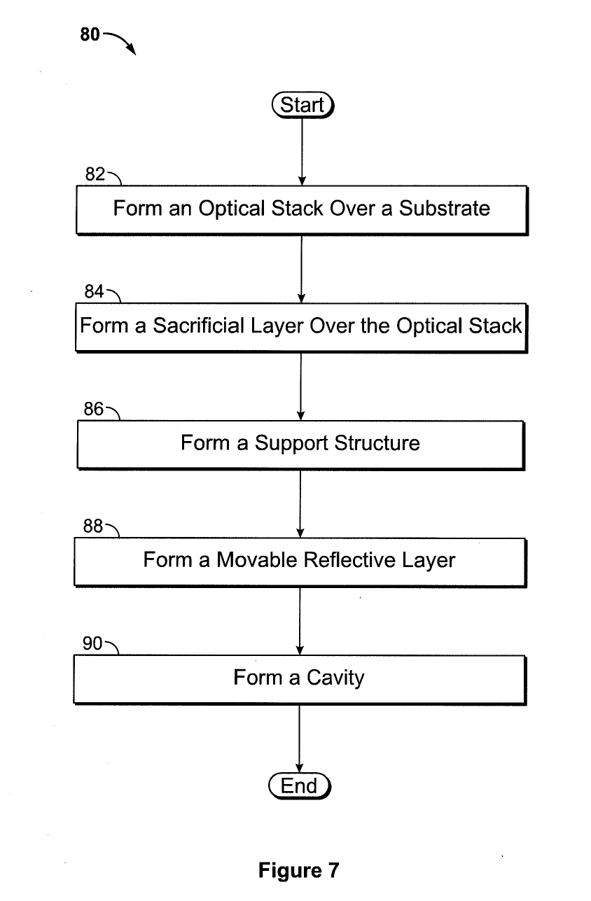

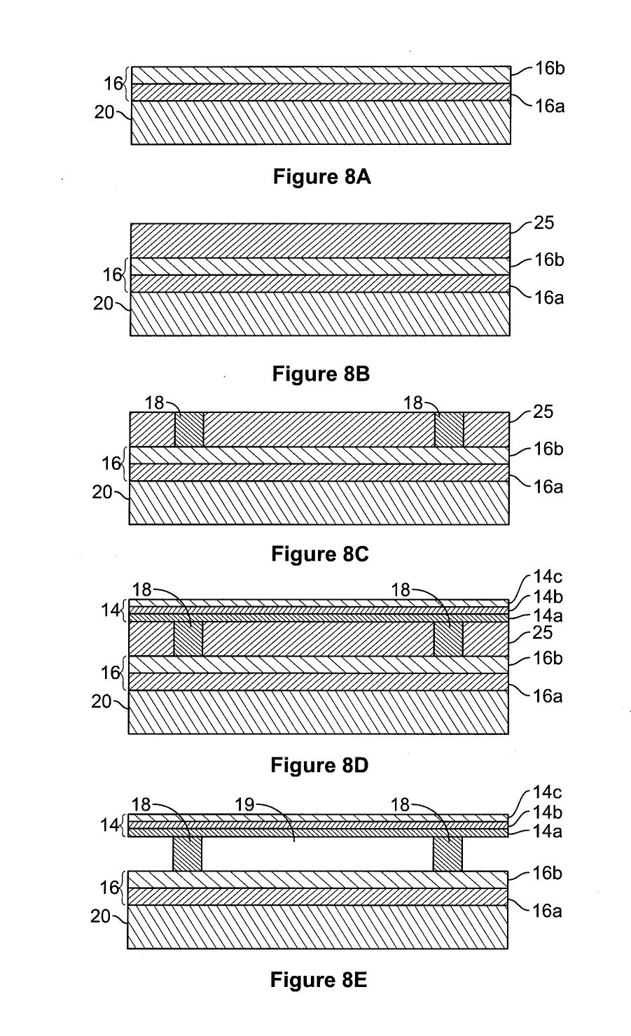

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning to remove portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

As described above, FIG. 3 shows an example of the hysteresis characteristics of an interferometric modulator. In an array of interferometric modulators, such as the array illustrated in FIG. 2, each interferometric modulator can have slightly different hysteresis characteristics.

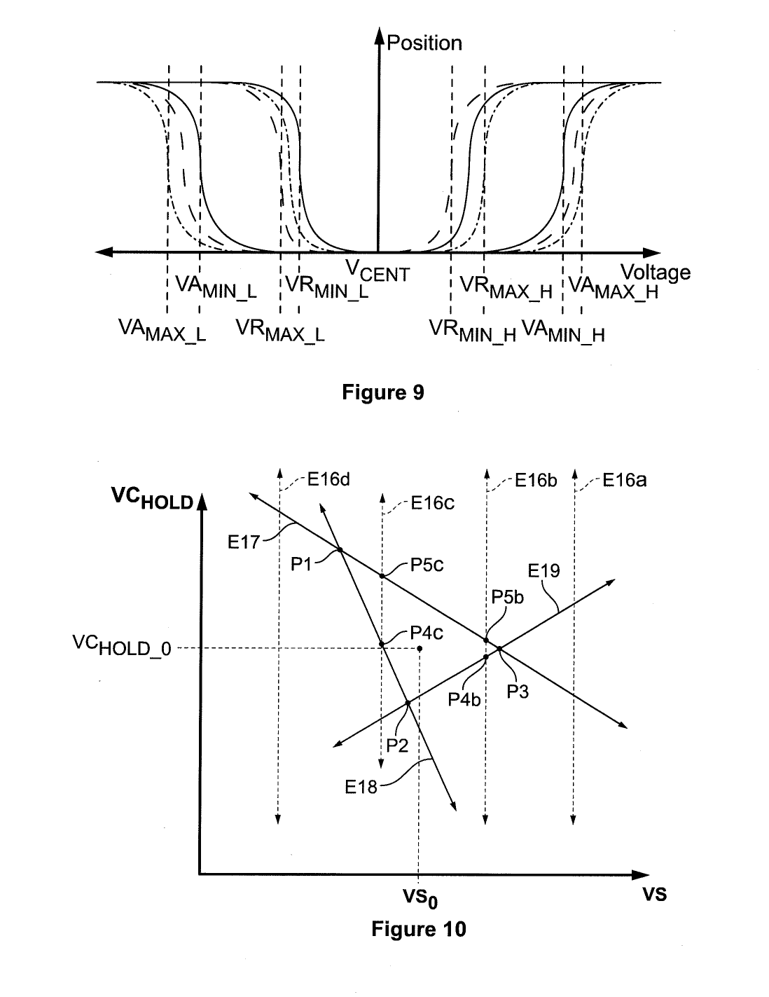

FIG. 9 shows an example of a diagram illustrating movable reflective mirror position versus applied voltage for several members of an array of interferometric modulators. In this illustrated implementation, therefore, the display elements are interferometric modulators having characteristics as described above. The principles described further below may be applicable to other display element implementations as well. FIG. 9 is similar to FIG. 3, but illustrates variations in hysteresis curves among different modulators in the array. At a high actuation voltage above a center voltage (denoted V_{CENT} in FIG. 9) and at a low actuation voltage below the center voltage, each interferometric modulator changes from a released state to an actuated state. The high and low actuation voltages are denoted as VA values in FIG. 9. The center voltage is the midpoint between the positive hysteresis window and the negative hysteresis window. It can be defined in a variety of ways, e.g., halfway between the outer edges, halfway between the inner edges, or halfway between the midpoints of the two windows. For an array of modulators, the center voltage may be defined as the average center voltage for the different modulators of the array, or may be defined as midway between the extremes of the hysteresis windows for all the modulators. For example, with reference to FIG. 9, the center voltage may be defined as midway between the high actuation voltage and the low actuation voltage, e.g., the center voltage may be defined as (VA_{MAX}_{_{—}}_{H} VA_{MAX}_{_{—}}_{L})/2. As a practical matter, it is not particularly important how this value is determined, since the center voltage for an interferometric modulator is typically close to zero, and even when this is not the case, the various methods of calculating a midpoint between hysteresis windows will arrive at substantially the same value. In those implementations where the center voltage is offset from zero, this deviation may be referred to as the voltage offset. Similarly, at a high release voltage above the center voltage and at a low release voltage below the center voltage, the interferometric modulator changes from the actuated state to the released state. The high and low release voltages are denoted as VR values in FIG. 9. Although each interferometric modulator generally exhibits hysteresis, the edges of the hysteresis window are not at identical voltages for all modulators of the array. Thus, the actuation voltages and release voltages may be different for different interferometric modulators in an array. This can make it difficult to determine voltages to be used in a drive scheme, such as the drive scheme described above with respect to FIG. 4.

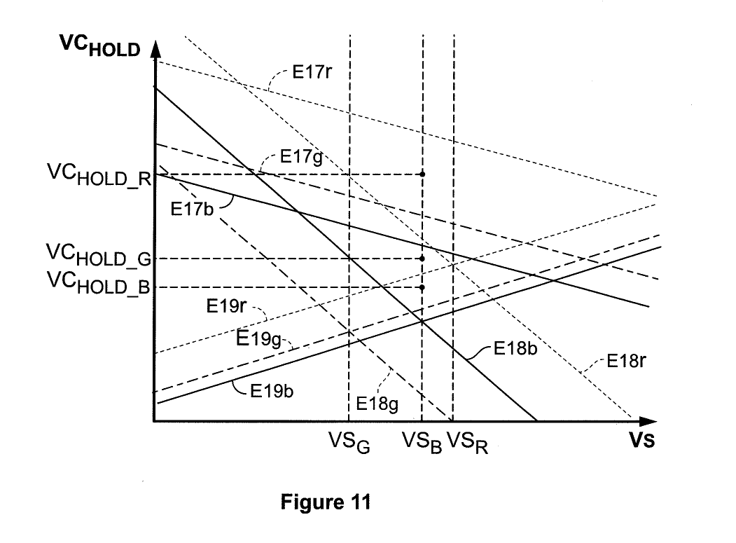

The array of interferometric modulators can be characterized by a number of different voltage levels illustrated in FIG. 9. For simplicity, the voltage levels for a monochrome array are first discussed with respect to FIGS. 9 and 10, followed by discussion of a color array with respect to FIG. 11. The array can have a high minimum actuation voltage (VA_{MAX}_{_{—}}_{H}) that is the lowest voltage above the center voltage at which at least one of the interferometric modulators changes from a released state to an actuated state. The array can have a high maximum actuation voltage (VA_{MAX}_{_{—}}_{H}) that is the lowest voltage above the center voltage at which all of the interferometric modulators change from the released state to the actuated state. The array can have a high maximum release voltage (VR_{MAX}_{_{—}}_{H}) that is the highest voltage above the center voltage at which at least one of the interferometric modulators changes from the actuated state to the released state. The array can have a high minimum release voltage (VR_{MIN}_{_{—}}_{H}) that is the highest voltage above the center voltage at which all of the interferometric modulators change from the actuated state to the released state.

These array voltages, also referred to as high array voltages, can be determined by applying an increasing or decreasing voltage to all or a subset of the interferometric modulators in the display substantially simultaneously and observing when one or only a few of the interferometric modulators have changed states or when all or substantially all of the interferometric modulators have changed states. The voltage may be increased or decreased slowly enough to allow an observer to recognize the value of the voltage when one or only a few of the interferometric modulators have changed states or when all or substantially all of the interferometric modulators have changed states. As used herein, the term observer includes both a human observer and an automatic observing system. An automatic observing system may include, for example and among other things, a camera, a digital image processor, a central processing unit, and controlling and processing software. Accordingly, VA_{MIN}_{_{—}}_{H} can be the lowest voltage above the center voltage at which an observer or an observing system detects that only one or a few interferometric modulators change from a released state to an actuated state, VA_{MAX}_{_{—}}_{H} can be the lowest voltage above the center voltage at which substantially all of the interferometric modulators have changed from the released state to the actuated state, VR_{MAX}_{_{—}}_{H} can be the highest voltage above the center voltage at which an observer or an observing system detects that only one or a few interferometric modulators have changed from the actuated to the released state when the applied voltage is ramped back down, and VR_{MIN}_{_{—}}_{H} can be the highest voltage above the center voltage at which all or substantially all of the interferometric modulators have changed from the actuated to the released state when the applied voltage is ramped back down.

Although the array voltages described above are described with respect to the positive voltage hysteresis window, e.g., the hysteresis window above the center voltage, the array can be further characterized by similar voltages described with respect to the negative voltage hysteresis window. For example, the array can have a low minimum actuation voltage (VA_{MIN}_{_{—}}_{L}) that is the highest voltage below the center voltage at which at least one of the interferometric modulators changes from a released state to an actuated state. The array can have a low maximum actuation voltage (VA_{MAX}_{_{—}}_{L}) that is the highest voltage below the center voltage at which all of the interferometric modulators change from the released state to the actuated state. The array can have a low maximum release voltage (VR_{MAX}_{_{—}}_{L}) that is the lowest voltage below the center voltage at which at least one of the interferometric modulators changes from the actuated state to the released state. The array can have a low minimum release voltage (VR_{MIN}_{_{—}}_{L}) that is the lowest voltage below the center voltage at which all of the interferometric modulators change from the actuated state to the released state. VA_{MIN}_{_{—}}_{L}, VA_{MAX}_{_{—}}_{L}, VR_{MAX}_{_{—}}_{L}, and VR_{MIN}_{_{—}}_{L} may be collectively referred to as low array voltages.

The low array voltages can be determined in a similar manner as described above with respect to the high array voltages. For example, the low array voltages can be determined by an observer or an observing system noting changes in state upon application of an increasing or decreasing voltage.

The drive scheme characteristics described above with respect to FIG. 4 can be used to define a number of inequalities with respect to these high and low array voltages in order for the drive scheme to operate on all of the interferometric modulators without accidental actuation or release.

As shown in FIG. 4, when VC_{ADD}_{_{—}}_{H} and VS_{H} are applied to an interferometric modulator, the interferometric modulator does not change state. For this to be true for each interferometric in the array, in some implementations the difference between VC_{ADD}_{_{—}}_{H} and VS_{H} of FIG. 4 can be less than VA_{MIN}_{_{—}}_{H} and greater than VR_{MAX}_{_{—}}_{H} of FIG. 9, as shown in Equation (1).

VR_{MAX}_{_{—}}_{H}≦VC_{ADD}_{_{—}}_{H}−VS_{H}≦VA_{MIN}_{_{—}}_{H} (1)

When VC_{ADD}_{_{—}}_{H} and VS_{L} are applied to an interferometric modulator, the interferometric modulator actuates. For this to be true for each interferometric modulator in the array, in some implementations the difference between VC_{ADD}_{_{—}}_{H} and VS_{L} can be greater than VA_{MAX}_{_{—}}_{H} as shown in Equation (2).

VA_{MAX}_{_{—}}_{H}≦VC_{ADD}_{_{—}}_{H}−VS_{L} (2)

When VC_{HOLD}_{_{—}}_{H} and either VS_{H} or VS_{L} are applied to an interferometric modulator, the interferometric modulator does not change state. For this to be true for each interferometric modulator in the array, in some implementations the difference between VC_{HOLD}_{_{—}}_{H} and VS_{H} or VS_{L} can be less than VA_{MIN}_{_{—}}_{H} and greater than VR_{MAX}_{_{—}}_{H}, as shown in Equations (3) and (4).

VR_{MAX}_{_{—}}_{H}≦VC_{HOLD}_{_{—}}_{H}−VS_{H}≦VA_{MIN}_{_{—}}_{H} (3)

VR_{MAX}_{_{—}}_{H}≦VC_{HOLD}_{_{—}}_{H}−VS_{L}≦VA_{MIN}_{_{—}}_{H} (4)

When VC_{REL} and either VS_{H} or VS_{L} are applied to an interferometric modulator, the interferometric modulator releases. For this to be true for each interferometric modulator in the array in some implementations, the difference between VC_{REL} and VS_{H} or VS_{L} can be greater than VR_{MIN}_{_{—}}_{L} and less than VR_{MIN}_{_{—}}_{H} as shown in Equations (5) and (6).

VR_{MIN}_{_{—}}_{L}≦VC_{REL}−VS_{H}≦VR_{MIN}_{_{—}}_{H} (5)

VR_{MIN}_{_{—}}_{L}≦VC_{REL}−VS_{L}≦VR_{MIN}_{_{—}}_{H} (6)

When VC_{HOLD}_{_{—}}_{L} and either VS_{H} or VS_{L} are applied to an interferometric modulator, the interferometric modulator does not change state. For this to be true for each interferometric modulator in the array in some implementations, the difference between VC_{HOLD}_{_{—}}_{L} and VS_{H} or VS_{L} can be greater than VA_{MIN}_{_{—}}_{L} and less than VR_{MAX}_{_{—}}_{L}, as shown in Equations (7) and (8).

VA_{MIN}_{_{—}}_{L}≦VC_{HOLD}_{_{—}}_{L}−VS_{H}≦VR_{MAX}_{_{—}}_{L} (7)

VA_{MIN}_{_{—}}_{L}≦VC_{HOLD}_{_{—}}_{L}−VS_{L}≦VR_{MAX}_{_{—}}_{L} (8)

When VC_{ADD}_{_{—}}_{L} and VS_{H} are applied to an interferometric modulator, the interferometric modulator actuates. For this to be true for each interferometric modulator in the array in some implementations, the difference between VC_{ADD}_{_{—}}_{L} and VS_{H} can be less than VA_{MAX}_{_{—}}_{L} as shown in Equation (9).

VC_{ADD}_{_{—}}_{L}−VS_{H}≦VA_{MAX}_{_{—}}_{L} (9)

When VC_{ADD}_{_{—}}_{L} and VS_{L} are applied to an interferometric modulator, the interferometric modulator does not change state. For this to be true for each interferometric in the array, in some implementations the difference between VC_{ADD}_{_{—}}_{L} and VS_{L} can be greater than VA_{MIN}_{_{—}}_{L} and less than VR_{MAX}_{_{—}}_{L}, as shown in Equation (10).

VA_{MIN}_{_{—}}_{L}≦VC_{ADD}_{_{—}}_{L}−VS_{L}≦VR_{MAX}_{_{—}}_{L} (10)

By selecting the drive scheme voltages in accordance with Equations (1)-(10), accidental actuation and release of interferometric modulators can be reduced. Thus, in some implementations, a method of tuning a display includes determining one or more array voltages, such as VA_{MAX}_{_{—}}_{H}, VA_{MIN}_{_{—}}_{H}, VR_{MAX}_{_{—}}_{H}, VR_{MIN}_{_{—}}_{H}, VA_{MAX}_{_{—}}_{L}, VA_{MIN}_{_{—}}_{L}, VR_{MAX}_{_{—}}_{L}, VR_{MIN}_{_{—}}_{L}, and, based on the determined array voltages, determining one or more drive scheme voltages, such as VS_{H}, VS_{L}, VC_{ADD}_{_{—}}_{H}, VC_{HOLD}_{_{—}}_{H}, VC_{REL}, VC_{HOLD}_{_{—}}_{L}, and VC_{ADD}_{_{—}}_{L}. The determined drive scheme voltages can be selected such that one or more of the inequalities of Equations (1)-(10) are satisfied. In some implementations, the determined drive scheme voltages can be selected such that all of the inequalities of Equations (1)-(10) are satisfied.

Determination of the drive scheme voltages can be simplified with a number of assumptions. In some implementations, corresponding high and low drive scheme voltages can be selected as additive inverses of each other. For example, in some implementations, VS_{H} is selected as VS and VS_{L} is selected as −VS, VC_{ADD}_{_{—}}_{H} is selected as VC_{ADD} and VC_{ADD}_{_{—}}_{L} is selected as −VC_{ADD}, and VC_{HOLD}_{_{—}}_{H} is selected as VC_{HOLD} and VC_{HOLD}_{_{—}}_{L} is selected as −VC_{HOLD}. Thus, rather than seven variables, the drive scheme voltages can be represented by only four different variables, namely, VS, VC_{ADD}, VC_{HOLD}, and V_{REL}.

Determination of the drive scheme voltages can be simplified further by assuming that corresponding high and low array voltages are symmetric about a center voltage. For example, in some implementations, VA_{MAX}_{_{—}}_{H} is assumed to be VA_{MAX} and VA_{MAX}_{_{—}}_{L} is assumed to be −VA_{MAX}+V_{OFFSET}, VA_{MIN}_{_{—}}_{H} is assumed to be VA_{MIN} and VA_{MIN}_{_{—}}_{L} is assumed to be −VA_{MIN}+V_{OFFSET}, VR_{MAX}_{_{—}}_{H} is assumed to be VR_{MAX} and VR_{MAX}_{_{—}}_{L} is assumed to be −VR_{MAX}+V_{OFFSET}, and VR_{MIN}_{_{—}}_{H} is assumed to be VR_{MIN} and VR_{MIN}_{_{—}}_{L} is assumed to be −VR_{MIN}+V_{OFFSET}. In some implementations, the center voltage is assumed to be zero (V_{OFFSET}=0). Accordingly, in some implementations, VA_{MAX}_{_{—}}_{H} is assumed to be VA_{MAX} and VA_{MAX}_{_{—}}_{L} is assumed to be −VA_{MAX}, VA_{MIN}_{_{—}}_{H} is assumed to be VA_{MIN} and VA_{MIN}_{_{—}}_{L} is assumed to be −VA_{MIN}, VR_{MAX}_{_{—}}_{H} is assumed to be VR_{MAX} and VR_{MAX}_{_{—}}_{L} is assumed to be −VR_{MAX}, and VR_{MIN}_{_{—}}_{H} is assumed to be VR_{MIN} and VR_{MIN}_{_{—}}_{L} is assumed to be −VR_{MIN}.

These simplifications reduce the number of inequalities from ten (shown above in Equations (1)-(10)) to four (shown below in Equations (11)-(14)).

First, as implied by Equations (5) and (6), the sum of the release voltage, V_{REL}, and the segment voltage, VS, can be less than VR_{MIN} to ensure release of substantially all interferometric modulators in the array, as shown in Equation (11).

V_{REL}+VS≦VR_{MIN} (11)

Second, as implied by Equations (2) and (9), the sum of the address voltage, VC_{ADD}, and the segment voltage, VS, can be greater than VA_{MAX} to ensure actuation of substantially all interferometric modulators in the array, as shown in Equation (12).

VC_{ADD}+VS≧VA_{MAX} (12)

Third, as implied by Equations (1) and (10), the difference between the address voltage, VC_{ADD}, and the segment voltage, VS, can be less than VA_{MIN} to reduce accidental actuation of interferometric modulators in the array, as shown in Equation (13).

VC_{ADD}−VS≦VA_{MIN} (13)

Fourth, as implied by Equations (3) and (8), the difference between the hold voltage, VS, and the segment voltage, VS, can be greater than VR_{MAX} to reduce accidental release of interferometric modulators in the array, as shown in Equation (14).

VC_{HOLD}−VS≧VR_{MAX} (14)

If Equations (11)-(14) are satisfied and VC_{ADD} is greater than VC_{HOLD}, other inequalities based on Equations (1)-(10) are also satisfied. Thus, the simplifications above described reduce the number of drive scheme voltages to be determined into a solvable system of equations of four inequalities and four unknowns. The solution to the system is a region in four-dimensional space and selection of the particular voltages based on this solution can be difficult.

To simplify selection of the drive scheme voltages, V_{REL} can be selected as the voltage offset, V_{OFFSET}. The voltage offset can be selected based on the average of corresponding high and low array voltages. In some implementations, V_{OFFSET} is assumed to be zero. Thus, in some implementations, V_{REL} is selected as zero.

In some implementations, as determined by the hardware voltage supplier available, V_{ADD} is selected according to Equation (15) as the sum of the hold voltage, VC_{HOLD}, and twice the segment voltage, 2VS.

V_{ADD}=VC_{HOLD}+2VS (15)

In these implementations, Equations (11)-(14) can be reduced to a system of equations of four inequalities and two unknowns, as shown below in Equations (16)-(19).

VS≦VR_{MIN} (16)

VC_{HOLD}+3VS≧VA_{MAX} (17)

VC_{HOLD}+VS≦VA_{MIN} (18)

VC_{HOLD}−VS≧VR_{MAX} (19)

This system and the “solution space” can be illustrated in a two-dimensional graph.

FIG. 10 shows an example of a graph illustrating inequalities that can be used in selecting drive scheme voltages. As shown in FIG. 10, Equations (17)-(19), illustrated by line E17, line E18, and line E19 intersect to form a triangle in two-dimensional space with axes VS-VC_{HOLD}. The triangular region is defined by three points, denoted by P1, P2, and P3. The points can be determined by Equations (20)-(22) below.

$$\begin{matrix}P 1 = ( \frac{V {A}_{M A X} - V {A}_{M I N}}{2} , \frac{3 V {A}_{M IN} - {VA}_{M AX}}{2} ) & ( 20 ) \\ P 2 = ( \frac{V {A}_{M AX} - {VR}_{M AX}}{4} , \frac{3 {VR}_{M AX} + V {A}_{M AX}}{4} ) & ( 21 ) \\ P 3 = ( \frac{V {A}_{M I N} - {VR}_{MA X}}{2} , \frac{V {A}_{MI N} + {VR}_{M AX}}{2} ) & ( 22 )\end{matrix}$$

If VR_{MIN} is greater than (VA_{MAX}−VR_{MAX})/4, Equation (16) can be illustrated by line E16a, to the right of the P3, and the inequality does not influence the solution set. Thus, the solution set is the triangle defined by P1, P2, and P3. However, if VR_{MIN} is less than (VA_{MAX}−VR_{MAX})/4, but greater than (VA_{MIN}+VR_{MIN})/2, Equation (16) can be illustrated by line E16b, between P2 and P3, and the inequality reduces the solution set. In this case, the solution set is the quadrilateral defined by P1, P2, P4b, and P5b. P4b and P5b can be determined by Equations (23) and (24) below.

P4b=(VR_{MIN},VA_{MAX}−3VR_{MIN}) (23)

P5b=(VR_{MIN},VR_{MAX}+VR_{MIN}) (24)

If VR_{MIN} is less than (VA_{MIN}+VR_{MIN})/2, but greater than (VA_{MAX}−VA_{MIN})/2, Equation (16) can be illustrated by line E16c, between P1 and P2, and the inequality reduces the solution set. In this case, the solution set is the triangle defined by P1, P4c, and P5c. P4c and P5c can be determined by Equations (25) and (26) below.

P4c=(VR_{MIN},VA_{MAX}−3VR_{MIN}) (25)

P5c=(VR_{MIN},VA_{MAX}−VR_{MIN}) (26)

If VR_{MIN} is less than (VA_{MAX}−VA_{MIN})/2, there is no solution set. Typically, VR_{MIN} is greater than (VA_{MAX}−VR_{MAX})/4 and Equation (16) does not influence the solution set. Thus, determining drive scheme voltages can be further simplified by assuming that VR_{MIN} is greater than (VA_{MAX}−VR_{MAX})/4 and ignoring Equation (16), as is done below.

In some implementations, VS and VC_{HOLD} can be determined as those voltages corresponding to a point at or near the middle of the solution space. In some implementations, a selected VS can be determined as the VS midway between the greatest VS in the solution space and the least VS in the solution space. VC_{HOLD} can be determined by the VC_{HOLD} midway between the greatest VC_{HOLD} at this VS and the least VC_{HOLD} at this VS. Thus, in some implementations, VS is determined as VS₀ according to Equation (27) below. VC_{HOLD} can be determined based on this result. Thus, in some implementations, VC_{HOLD} is determined as VC_{HOLD}_{_{—}}₀ according to Equation (28) below.

$$\begin{matrix}{VS}_{0} = ( \frac{V {A}_{M AX} - {VR}_{M AX}}{4} ) & ( 27 ) \\ V {C}_{HOLD \_ 0} = \frac{V {A}_{M AX} + V {R}_{M A X}}{2} & ( 28 )\end{matrix}$$

The drive scheme voltage determinations described above may be used when a single VS and VC_{HOLD} are to be used for all the display elements of an entire array. For some display arrays, however, multiple VC_{HOLD} voltages may be derived for different portions of the array. This can be useful for color displays, where an EMS display includes display elements that are configured to preferentially reflect different colors when they are in the reflective state to produce a color display. In these implementations, some display elements may reflect red, some may reflect blue, and some may reflect green, or any combination of these colors, so as to form pixels from groups of different color display elements with color reproduction capabilities. One of ordinary skill in the art would appreciate that red, green, and blue are but one choice of primary color combination that may be implemented. Other combination of primary colors can be used in other implementations. The different color display elements may have different physical characteristics such as different gap sizes. Thus, there is a relatively wide variation in hysteresis curves for display elements of different colors, and more uniformity of hysteresis curves between display elements of the same color. In some implementations, each display element in a particular common line is associated with the same color. Typically, the common lines alternate colors, such as a red row, a green row, a blue row, a red row, a green row, a blue row, and so on down the display array. In these implementations, the common line driver circuit can be configured to apply different VC_{HOLD} voltages to different color common lines.

Thus, whereas the segment voltages applied to each column by the column driver circuit are applied to display elements of all colors, the common voltages applied to each row by the row driver circuit are applied only to display elements of a single color. In these implementations, the drive scheme may include a single segment voltage, VS, that is applied to all colors, and different hold voltages for each color, including VC_{HOLD}_{_{—}}_{R}, VC_{HOLD}_{_{—}}_{G}, and VC_{HOLD}_{_{—}}_{B} for red display elements, green display elements, and blue display elements, respectively.

Thus, in some implementations, a method of tuning a multi-color display includes determining one or more array voltages as described above separately for each of a number of colors and, based on the determined array voltages for each color, determining one or more drive scheme voltages. The determined array voltages can include, for example, determining values for VA_{MAX}, VA_{MIN}, VR_{MAX}, and VR_{MTN} for each set of different color display elements in the array. The different array voltages associated with different colors are denoted by appending R, G, or B to the subscript. For example, VA_{MAX}_{_{—}}_{R} can be the lowest voltage at which substantially all of the red display elements change from a released state to an actuated state. As another example, VR_{MAX}_{_{—}}_{G} can be the highest voltage at which at least one of the green display elements change from the actuated state to the released state.

FIG. 11 shows an example of a graph illustrating inequalities that can be used in selecting drive scheme voltages for multiple colors. As shown in FIG. 11, Equations (17)-(19) as applied to array values associated with just the red display elements of the array are illustrated by lines E17r, E18r, and E19r. Similarly, Equations (17)-(19) as applied to array values associated with just the green display elements of the array are illustrated by lines E17g, E18g, and E19g and Equations (17)-(19) as applied to array values associated with just the blue display elements of the array are illustrated by lines El7b, E18b, and E19b. The three sets of inequalities define three solution spaces.

Based on these solution spaces, a segment voltage, VS, for the entire array and hold voltages for each color, VC_{HOLD}_{_{—}}_{R}, VC_{HOLD}_{_{—}}_{G}, and VC_{HOLD}_{_{—}}_{B}, can be determined. In some implementations, a segment voltage is first selected such that each solution space overlaps the selected segment voltage. In some implementations, a segment voltage for each color, i.e., VS_{R}, VS_{G}, and VS_{B}, is determined by substituting the measured values for VA_{MAX}, VR_{MAX}, and VA_{MIN} for each color separately into Equation (27) above. A global VS may be determined based on these color specific segment voltages. In some implementations, VS₀ for the whole array is determined as a selection of one of VS_{R}, VS_{G}, or VS_{B}, which are each determined as above. In some implementations, VS₀ can be determined as the lowest of VS_{R}, VS_{G}, and VS_{B}. In some other implementations, VS₀ can be determined as the segment voltage associated with the color having the solution space with the smallest area. This is illustrated in FIG. 11 where VS_{B} is used as a global VS. An average of VS_{R}, VS_{G}, and VS_{B} can also be selected as the array segment voltage VSₒ.

Once a VS₀ is selected, VC_{HOLD}_{_{—}}_{R}, VC_{HOLD}_{_{—}}_{G}, and VC_{HOLD}_{_{—}}_{B}, can be independently determined for each separate color by using the values for VA_{MAX}, VR_{MAX}, and VA_{MIN} for each color and the selected global VS₀ in Equations (29) and (30) below.

$$\begin{matrix}V {C}_{HOLD \_ 0} = \frac{V {A}_{MI N} + {VR}_{MA X}}{2} if {VS}_{0} \geq ( V {A}_{MA X} - {VR}_{M A X} ) / 4 & ( 29 ) \\ {VC}_{HOLD \_ 0} = ( V {A}_{MI N} + V {A}_{MA X} - 4 {VS}_{0} ) / 2 if {VS}_{0} < ( V {A}_{MA X} - {VR}_{MA X} ) / 4 & ( 30 )\end{matrix}$$

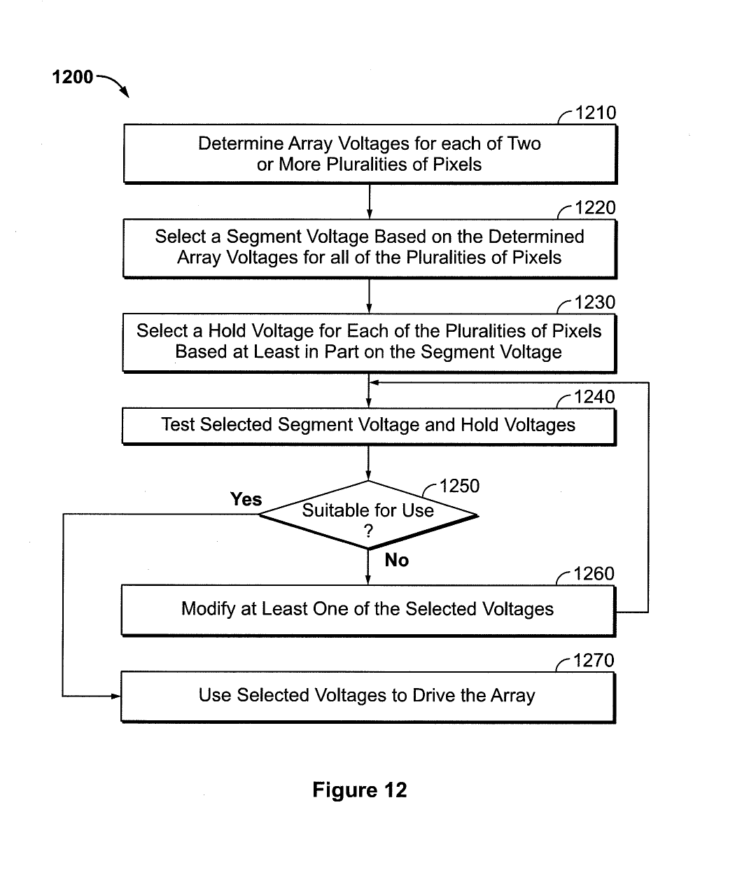

FIG. 12 shows an example of a flow diagram illustrating a method of selecting drive scheme voltages. In some implementations, the method 1200 can be performed to select drive scheme voltages for an array including two or more pluralities of display elements, such as an array with different color display elements. For example, the array can include three pluralities of display elements, where the first plurality of display elements are red display elements, the second plurality of display elements are green display elements, and the third plurality of display elements are blue display elements.

The method 1200 begins, at block 1210, with the determination of array voltages for each of the two or more pluralities of display elements. In some implementations, the array voltages for a particular plurality of display elements can include a first voltage, the lowest voltage above a center voltage which, when applied to all of the plurality of display elements, causes at least one of the display elements within the plurality of display elements to actuate; a second voltage, the lowest voltage above the center voltage which, when applied to all of the plurality of display elements, causes substantially all of the plurality of display elements to actuate; a third voltage, the highest voltage above the center voltage which, when applied to all of the plurality of display elements, causes at least one of the display elements within the plurality of display elements to release; and a fourth voltage, the highest voltage above the center voltage which, when applied to all of the plurality of display elements, causes substantially, all of the display elements within the plurality of display elements to release.

In some implementations, the array voltages are determined by applying a variable voltage to each of the pluralities of display elements while grounding the other pluralities of display elements. For example, to determine the array voltages for a first plurality of display elements, the voltage applied to the first plurality of display elements may be about 1 volt, whereas the voltage applied to the other pluralities of display elements may be about zero volt. Then the voltage applied to the first plurality of display elements is then increased until at least one of the display elements within the first plurality of display elements actuates. The voltage at which this occurs can be recorded as the first voltage. The voltage applied to the first plurality of display elements is further increased until substantially all of the display elements within the first plurality of display elements actuate. The voltage at which this occurs can be recorded as the second voltage. The voltage applied to the first plurality of display elements is then decreased until at least one of the display elements within the first plurality of display elements releases. The voltage at which this occurs can be recorded as the third voltage. The voltage applied to the first plurality of display elements is then further decreased until substantially all of the display elements within the first plurality of display elements release. The voltage at which this occurs can be recorded as the fourth voltage. This process can be repeated for each of the remaining pluralities of display elements.

As described above, in some implementations, the high and low array voltages are symmetric about a center voltage. Typically the center voltage is close to zero. However, in some implementations, the center voltage is offset from zero by an amount referred to as the voltage offset. In some implementations, the voltage offset is assumed to be zero. However, in some other implementations, the method 1200 can include determining the voltage offset. Furthermore, the method 1200 can include separately determining the high and low array voltages.

In block 1220, a segment voltage based on the determined array voltages is selected for all of the pluralities of display elements. In some implementations, a plurality-specific segment voltage is determined for each plurality of display elements, and the segment voltage is determined based on these plurality-specific segment voltages. In some implementations, the plurality-specific segment voltages are determined using Equation (27) above. In some implementations, the segment voltage is selected as one of the plurality-specific segment voltages. In some implementations, the segment voltage is selected as the smallest of the plurality-specific segment voltages. In some implementations, the segment voltage is selected as the plurality-specific segment voltage associated with the plurality of display elements having the smallest margin of error, e.g., the plurality-specific segment voltage associated with the plurality of display elements having the smallest solution space.

In block 1230, a hold voltage is selected for each of the pluralities of display elements based at least in part on the segment voltage. In some implementations, the hold voltage for a particular plurality of display elements is based on the segment voltage common to all of the pluralities of display elements and the array voltages determined for the particular plurality of display elements. In some implementations, the hold voltages are determined using Equation (28) above.

In block 1240, the selected segment voltage and hold voltages are tested by applying them to the array in accordance with the drive scheme. In block 1250, it is determined whether the selected voltages are suitable for use in the drive scheme. It can be determined, in some implementations, that the selected voltages are suitable for use in the drive scheme if the voltages effect actuation and release of substantially all display elements when this is expected and do not result in inadvertent actuation or release. This can be tested visually by a person or with an automated system by displaying test patterns on the display. The test patterns may be designed to accentuate the appearance of incorrectly actuated or unactuated display elements.

If it is determined, in block 1250, that the selected voltages are suitable for use in the drive scheme, the method 1200 continues to block 1270 when the selected voltages are used to drive the array in operation. Alternatively, if it is determined, in block 1250, that the selected voltages are not suitable for use in the drive scheme, the method 1200 continues to block 1260, where at least one of the selected voltages is modified. The selected voltages can be modified, in some implementations, by increasing or decreasing one or more of the selected voltages by approximately 100 mV or 200 mV, or any suitable value that is close to the smallest voltage change that produces a noticeable change in the number of display elements actuated. The method 1200 then repeats blocks 1240, 1250, and 1260 until voltages suitable for use in the drive scheme are selected.

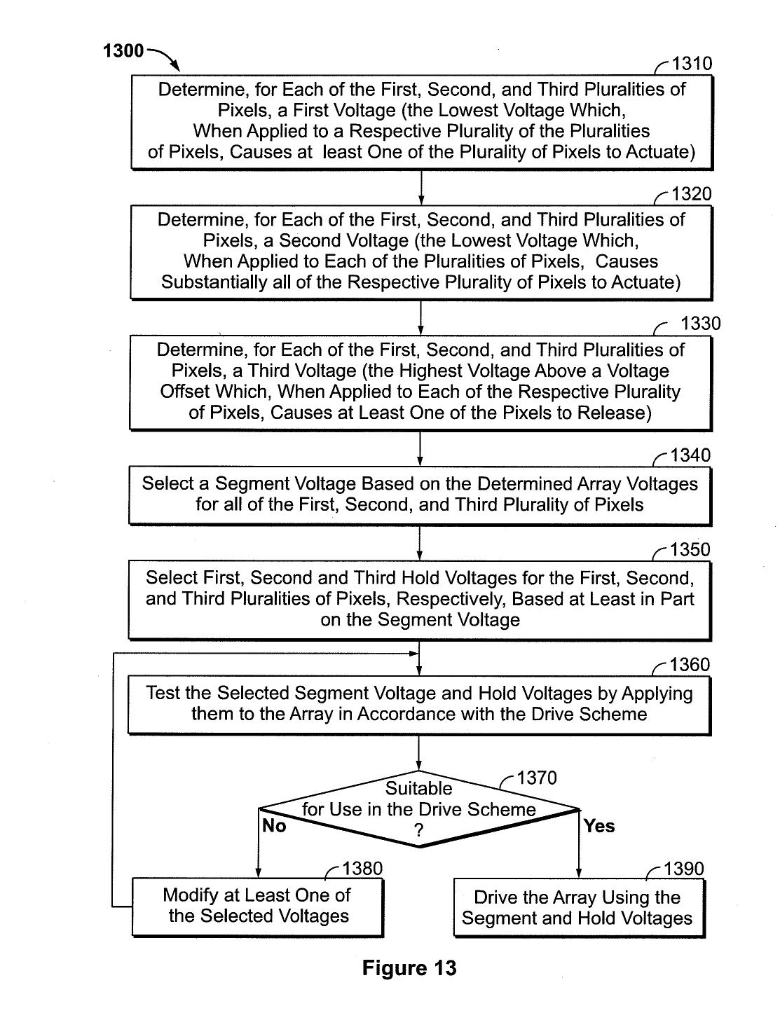

FIG. 13 shows an example of a flow diagram illustrating a method of driving an array. In some implementations, the method 1300 can be performed to drive an array including a first plurality of display elements of a first color, a second plurality of display elements for a second color, and a third plurality of display elements of a third color. As described above, in some implementations, the high and low array voltages are symmetric about the center voltage. Typically the center voltage is close to zero. However, in some implementations, the center voltage is offset from zero by an amount referred to as the voltage offset. In some implementations, the voltage offset is assumed to be zero. The test procedure described below can be performed with reference to either the negative hysteresis window or the positive hysteresis window. Accordingly, the terms “lowest voltage” and “highest voltage” used herein refer to smallest absolute value voltage and largest absolute value voltage with the polarity of voltage with respect to the center voltage being the polarity suitable for the polarity of hysteresis window being tested.

The method 1300 begins, at block 1310, with the determination, for each of the first, second, and third plurality of display elements, of a first voltage, the lowest voltage which, when applied to a respective plurality of the pluralities of display elements, causes at least one of the display elements within the respective plurality of display elements to actuate.

The method 1300 continues, in block 1320, with the determination, for each of the first, second, and third plurality of display elements, of a second voltage, the lowest voltage which, when applied to each of the plurality of display elements, causes substantially all of the display elements within the respective plurality of display elements to actuate. The method 1300 continues, in block 1330, with the determination, for each of the first, second, and third plurality of display elements, of a third voltage, the highest voltage which, when applied to each display element of the respective plurality of display elements, causes at least one of the display elements to release.

In some implementations, the first, second, and third voltages are determined by applying a variable voltage to each of a respective plurality of the pluralities of display elements while grounding the other pluralities of display elements. For example, to determine the first, second, and third voltages for the first plurality of display elements, the voltage applied to the first plurality of display elements is approximately 1 volt, whereas the voltage applied to the second and third pluralities of display elements is about zero volt. Then the voltage applied to the first plurality of display elements is increased until at least one of the display elements within the first plurality of display elements actuates. The voltage at which this occurs can be recorded as the first voltage. The voltage applied to the first plurality of display elements is further increased until substantially all of the display elements within the first plurality of display elements actuate. The voltage at which this occurs can be recorded as the second voltage. The voltage applied to the first plurality of display elements is then decreased until at least one of the display elements within the first plurality of display elements releases. The voltage at which this occurs can be recorded as the third voltage. This process can be repeated for the second and third pluralities of display elements.

In some implementations, the method 1300 can further include determining a fourth voltage, the highest positive voltage which, when applied to all of the pluralities of display elements, causes substantially all of the pluralities of display elements to release. The first, second, and third voltages, and optionally, the fourth voltage, determined above can be collectively referred to as the array voltages.

In block 1340, a segment voltage based on the determined array voltages is selected for all of the first, second, and third plurality of display elements. In some implementations, a plurality-specific segment voltage is determined for each plurality of display elements, and the segment voltage is determined based on these plurality-specific segment voltages. In some implementations, the plurality-specific segment voltages are determined using Equation (27) above. In some implementations, the segment voltage is selected as one of the plurality-specific segment voltages. In some implementations, the segment voltage is selected as the smallest of the plurality-specific segment voltages. In some implementations, the segment voltage for the whole array is selected as the plurality-specific segment voltage associated with the plurality of display elements having the smallest margin of error, e.g., the plurality-specific segment voltage associated with the plurality of display elements having the smallest solution space.

In block 1350, first, second, and third hold voltages are selected for the first, second, and third pluralities of display elements, respectively, based on, at least in part, the segment voltage. In some implementations, the hold voltage for a particular plurality of display elements is based on the segment voltage and the array voltages determined for the particular plurality of display elements. In some implementations, the hold voltages are determined using Equation (28) above.

In block 1360, the selected segment voltage and hold voltages are tested by applying them to the array in accordance with the drive scheme. In block 1370, it is determined whether the selected voltages are suitable for use in the drive scheme. It can be determined, in some implementations, that the selected voltages are suitable for use in the drive scheme if the voltages effect actuation and release of substantially all display elements when this is expected and do not result in inadvertent actuation or release.

If it is determined, in block 1370, that the selected voltages are suitable for use in the drive scheme, the method 1300 continues to block 1390 where the selected voltages are used to drive the array in operation. Alternatively, if it is determined, in block 1370, that the selected voltages are not suitable for use in the drive scheme, the method 1300 continues to block 1380, where at least one of the selected voltages is modified. The selected voltages can be modified, in some implementations, by increasing or decreasing the selected voltages by small increments with respect to the full actuation and release voltage range, such as, approximately 100 mV or 200 mV. The method 1300 then repeats blocks 1360, 1370, and 1380 until selected voltages suitable for use in the drive scheme are determined.

The methods described above can be performed on a fully or partially automated test fixture having processing circuitry configured to control the display to apply test voltages to the display elements and detect the actuation response of the display elements to the test voltages. In such an implementation, the segment electrodes for the array can be held at about zero volt by the fixture, as a variable voltage is applied to the common lines associated with a particular color of the array. Onset of display element actuation, and the completion of display element actuation can be detected visually (manually or by machine vision using optical sensors with automation), or by line capacitance measurement (a.k.a., self-calibration). By varying the applied voltage and detecting the response, VA_{MAX}, VR_{MAX}, and VA_{MIN} for the color can be determined. This can be repeated for all the colors, and Equations (27) and (28) can be used as described above to derive a set of drive voltages, including the segment voltage and hold voltages described above, for the array under test.

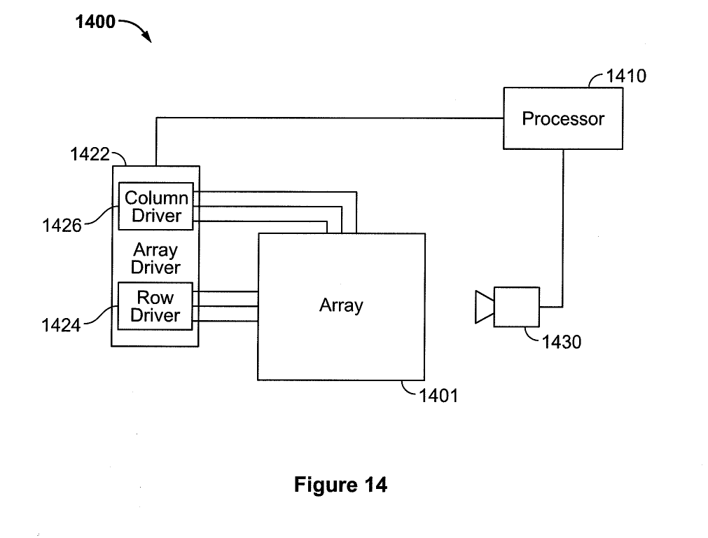

FIG. 14 shows an example of a system block diagram illustrating such a test fixture. The text fixture is coupled to an array 1401, also referred to as the device under test. The array may be, for example, an array of interferometric modulators as described above with respect to array 30 of FIG. 2. The array 1401 is driven with an array driver 1422 that includes a row driver circuit 1424 and a column driver circuit 1426. The array driver 1422 may operate according to the principles described above with respect to the array driver 22 of FIG. 2. The array driver 1424 is in communication with a processor 1410. The processor may operate at least according to the principles described above with respect to the processor 21 of FIG. 2. For example, the processor 1410 may provide information to the array driver 1422 regarding voltages to be applied to the array 1401. The processor 1410 may further operate to perform at least part of the methods 1200 and 1300 of FIGS. 12 and 13. For example, the processor 1410 may be in communication with an optical sensor 1430 to determine when one or only a few of the display elements of the array 1401 have changed states or when all or substantially all of the display elements of the array 1401 have changed states. The optical sensor 1430 may include, for example, a camera, vision system, camera, sensor, lens, laser vibrometer system, etc. The processor 1401 may also be configured to determine when one or only a few of the display elements of the array 1401 have changed states or when all or substantially all of the display elements of the array 1401 have changed states without using the optical sensor 1430 but by detecting display element actuation using a capacitance sensing method using driver specially configured for this purpose. With this implementation, the driver circuit incorporates charge or voltage sensors that detect the capacitance change of the display elements between the actuated and unactuated states under different applied voltages.

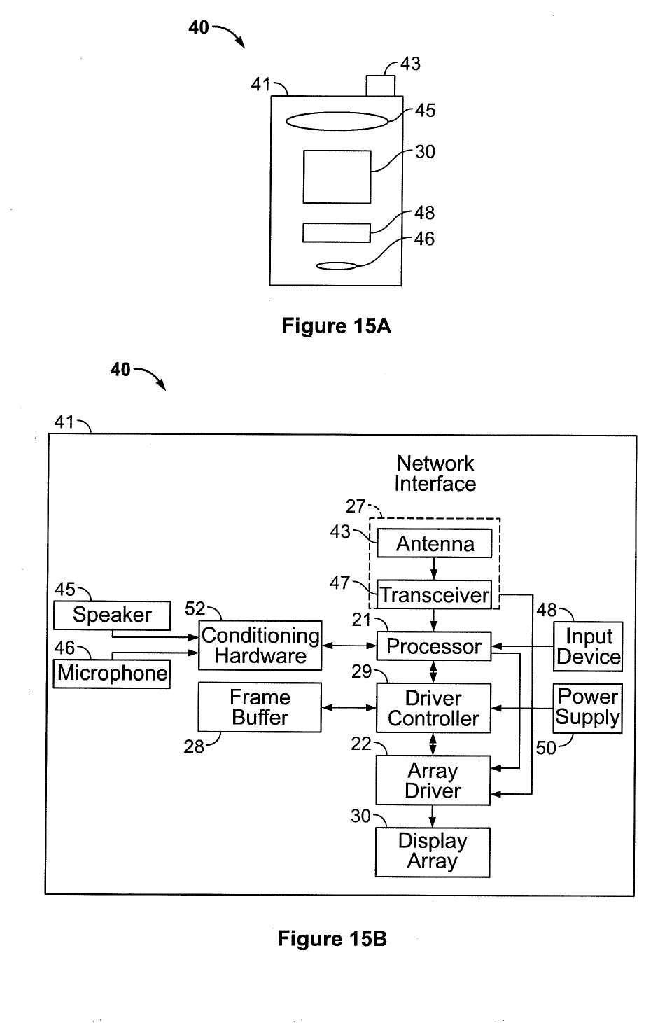

FIGS. 15A and 15B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 15B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of calibrating a display, the method comprising:
determining, for each of a first, second, and third pluralities of display elements of the display, the first plurality of display elements being associated with a first color, the second plurality of display elements being associated with a second color, and the third plurality of display elements being associated with a third color, a first voltage, the lowest voltage which, when applied to each display element of a respective plurality of the pluralities of display elements, causes at least one display element of the respective plurality of display elements to actuate;
determining, for each of the first, second, and third pluralities of display elements, a second voltage, the lowest voltage which, when applied to each of the respective plurality of display elements, causes substantially all of the display elements within the respective plurality of display elements to actuate;
determining, for each of the first, second, and third pluralities of display elements, a third voltage, the highest voltage which, when applied to each display element of the respective plurality of display elements, causes at least one display element of the respective plurality of display elements to release;
selecting a segment voltage based on the determined first, second, and third voltages; and
selecting first, second, and third hold voltages for the first, second, and third pluralities of display elements, respectively, based at least in part on the segment voltage.

2. The method of claim 1, further comprising selecting one or more drive scheme voltages based at least in part on the selected segment voltage and the first, second, and third hold voltages.

3. The method of claim 1, further comprising modifying at least one of the selected segment voltage and the first, second, and third hold voltages for use in a drive scheme.

4. The method of claim 1, further comprising:
applying the selected segment voltage and the first, second, and third hold voltages to the display in accordance with a drive scheme; and
determining whether the selected segment voltage and the first, second, and third hold voltages are suitable for use in the drive scheme.

5. The method of claim 1, further comprising determining, for each of the first, second, and third pluralities of display elements, a fourth voltage, the highest positive voltage which, when applied to each display element of the respective plurality of the pluralities of display elements, causes substantially all of the display elements within the respective plurality of display elements to release.

6. The method of claim 1, wherein selecting a segment voltage comprises:
determining a first, second, and third potential segment voltage based, respectively, on the determined first, second, and third voltages for the first, second, and third pluralities of display elements; and
selecting one of the first, second, and third potential segment voltages as the selected segment voltage.

7. The method of claim 6, wherein selecting one of the first, second, and third potential segment voltages includes selecting the potential segment voltage with the lowest magnitude.

8. The method of claim 6, wherein each plurality of the pluralities of display elements is associated with a solution space and wherein selecting one of the first, second, and third potential segment voltages includes selecting the potential segment voltage associated with the plurality of display elements associated with the solution space having the smallest area.

9. A system for calibrating a display, the system comprising:
an array driver configured to apply a voltage to the first, second, and third pluralities of display elements of the display, the first plurality of display elements being associated with a first color, the second plurality of display elements being associated with a second color, and the third plurality of display elements being associated with a third color; and
a processor configured to:
control the array driver;
determine, for each of the first, second, and third pluralities of display elements, a first voltage, the lowest voltage which, when applied to each display element of a respective plurality of the pluralities of display elements, causes at least one display element of the respective plurality of display elements to actuate;
determine, for each of the first, second, and third pluralities of display elements, a second voltage, the lowest voltage which, when applied to each display element of the respective plurality of display elements, causes substantially all of the display elements within the respective plurality of display elements to actuate;
determine, for each of the first, second, and third pluralities of display elements, a third voltage, the highest voltage which, when applied to each display element of the respective plurality of display elements, causes at least one display element of the respective display elements to release;
select a segment voltage based on the determined first, second, and third voltages; and
select first, second, and third hold voltages for the first, second, and third pluralities of display elements, respectively, based at least in part on the segment voltage.

10. The system of claim 9, wherein the processor is further configured to select one or more drive scheme voltages based at least in part on the selected segment voltage and the first, second, and third hold voltages.

11. The system of claim 9, wherein the processor is further configured to modify at least one of the selected segment voltage and the first, second, and third hold voltages for use in a drive scheme.

12. The system of claim 9, wherein the processor is configured to control the array driver to apply the selected segment voltage and the first, second, and third hold voltages to the display in accordance with a drive scheme and to determine whether the selected segment voltage and the first, second, and third hold voltages are suitable for use in the drive scheme.

13. The system of claim 9, wherein the processor is further configured to determine, for each of the first, second, and third pluralities of display elements, a fourth voltage, the highest positive voltage which, when applied to each display element of the respective plurality of the pluralities of display elements, causes substantially all of the display elements within the respective plurality of display elements to release.

14. The system of claim 9, wherein the processor is configured to select a segment voltage by:
determining a first, second, and third potential segment voltage based, respectively, on the determined first, second, and third voltages for the first, second, and third pluralities of display elements; and
selecting one of the first, second, and third potential segment voltages as the selected segment voltage.

15. The system of claim 14, wherein the processor is configured to select one of the first, second, and third potential segment voltages by selecting the potential segment voltage with the lowest magnitude.

16. The system of claim 14, wherein each plurality of the pluralities of display elements is associated with a solution space and wherein the processor is configured to select one of the first, second, and third potential segment voltages by selecting the potential segment voltage associated with the plurality of display elements associated with the solution space having the smallest area.

17. A system for calibrating a display, the system comprising:
means for determining, for each of a first, second, and third pluralities of display elements, the first plurality of display elements being associated with a first color, the second plurality of display elements being associated with a second color, and the third plurality of display elements being associated with a third color, a first voltage, the lowest voltage which, when applied to each display element of a respective plurality of the pluralities of display elements, causes at least one display element of the respective plurality of display elements to actuate;
means for determining, for each of the first, second, and third pluralities of display elements, a second voltage, the lowest voltage which, when applied to each display element of the respective plurality of display elements, causes substantially all of the display elements within the respective plurality of display elements to actuate;
means for determining, for each of the first, second, and third pluralities of display elements, a third voltage, the highest voltage which, when applied to each display element of the respective plurality of display elements, causes at least one of the display elements to release;
means for selecting a segment voltage based on the determined first, second, and third voltages; and
means for selecting first, second, and third hold voltages for the first, second, and third pluralities of display elements, respectively, based at least in part on the segment voltage.

18. The system of claim 17, further comprising means for selecting one or more drive scheme voltages based at least in part on the selected segment voltage and the first, second, and third hold voltages.

19. The system of claim 17, further comprising means for modifying at least one of the selected segment voltage and the first, second, and third hold voltages for use in a drive scheme.

20. The system of claim 17, further comprising:
means for applying the selected segment voltage and the first, second, and third hold voltages to the display in accordance with a drive scheme; and
means for determining whether the selected segment voltage and the first, second, and third hold voltages are suitable for use in the drive scheme.

21. The system of claim 17, further comprising means for determining, for each of the first, second, and third pluralities of display elements, a fourth voltage, the highest positive voltage which, when applied to each display element of the respective plurality of the pluralities of display elements, causes substantially all of the display elements wtihin the respective plurality of display elements to release.

22. The method of claim 17, wherein the means for selecting a segment voltage comprises:
means for determining a first, second, and third potential segment voltage based, respectively, on the determined first, second, and third voltages for the first, second, and third plurality of display elements; and
means for selecting one of the first, second, and third potential segment voltages as the selected segment voltage.

23. A computer-readable storage medium having computer-executable instructions encoded thereon for performing a method of calibrating a display, the method comprising:
determining, for each of a first, second, and third pluralities of display elements, the first plurality of display elements being associated with a first color, the second plurality of display elements being associated with a second color, and the third plurality of display elements being associated with a third color, a first voltage, the lowest voltage which, when applied to each display element of a respective plurality of the pluralities of display elements, causes at least one display element of the respective plurality of display elements to actuate;
determining, for each of the first, second, and third pluralities of display elements, a second voltage, the lowest voltage which, when applied to each display element of the respective plurality of display elements, causes substantially all of the display elements within the respective plurality of display elements to actuate;
determining, for each of the first, second, and third pluralities of display elements, a third voltage, the highest voltage which, when applied to each display element of the respective plurality of display elements, causes at least one of the display elements to release;
selecting a segment voltage based on the determined first, second, and third voltages; and
selecting first, second, and third hold voltages for the first, second, and third pluralities of display elements, respectively, based at least in part on the segment voltage.

24. The computer-readable storage medium of claim 23, wherein the method further comprises selecting one or more drive scheme voltages based at least in part on the selected segment voltage and the first, second, and third hold voltages.

25. The computer-readable storage medium of claim 23, wherein the method further comprises modifying at least one of the selected segment voltage and the first, second, and third voltages for use in a drive scheme.

26. The computer-readable storage medium of claim 23, wherein the method further comprises:
applying the selected segment voltage and the first, second, and third hold voltages to the display in accordance with a drive scheme; and
determining whether the selected segment voltage and the first, second, and third hold voltages are suitable for use in the drive scheme.

27. The computer-readable storage medium of claim 23, wherein the method further comprises determining, for each of the first, second, and third pluralities of display elements, a fourth voltage, the highest positive voltage which, when applied to each display element of the respective plurality of the pluralities of display elements, causes substantially all of the display elements within the respective plurality of display elements to release.

28. The computer-readable storage medium of claim 23, wherein selecting a segment voltage comprises:
determining a first, second, and third potential segment voltage based, respectively, on the determined first, second, and third voltages for the first, second, and third pluralities of display elements; and
selecting one of the first, second, and third potential segment voltages as the selected segment voltage.
